(19) United States
(12) Patent Application Publication
(10) Pub. No.: US 2008/0126147 A1
(43) Pub. Date: May 29, 2008

(54) Determining method for exposure of a service

(76) Inventors: Jenny Siew Hoon Ang, San Francisco, CA (US); Ali P. Arsanjani, Fairfield, IA (US); Lyubov Cherbakov, McLean, VA (US); George M. Galambos, Montreal (CA); Kerrie Lamont Holley, Montara, CA (US); David Hugh Janson, Raleigh, NC (US)

Correspondence Address: IBM CORPORATION, IPLAW SHCB/40-3, 1701 NORTH STREET, ENDICOTT, NY, 13760, US

(21) Appl. No.: 11/496,893

(22) Filed: Jul. 31, 2006

(51) Int. Cl. G06Q 10/00

(52) U.S. Cl. 705/7

(57) ABSTRACT

Candidate services are identified using goal-service modeling or other techniques. A candidate service is tested using a business alignment test, a composability test, an externalized service description test, and a redundancy test. When all tests are successfully passed, the candidate service is exposed for use in a client solution, such as implementation as a service-oriented architecture.

This is related to Application No. ______ filed ______ titled “GOAL-SERVICE MODELING”, which is hereby incorporated herein by reference.

### TECHNICAL FIELD

The invention relates to methods of engaging a client company for the purpose of business transformation. More particularly, the invention relates to methods for moving from prior art business models created through component business modeling or other techniques to new models required by a service-oriented architecture solution design.

### BACKGROUND OF THE INVENTION

Object-oriented applications are built on the structuring elements of classes and objects. More recent business modeling techniques group objects into components and expose interfaces. Components, therefore, have become the primary structuring unit of business software applications. Components represent a run-time deployable unit of functionality.

For example, Rackham in US Patent application US2005/0203784 describes a method of providing business process services to a client company through components of activities. The components are groups of cohesive business activities supported by appropriate processes, applications, infrastructure, and metrics. Veryard describes component modeling in his book, The Component Based Business, published by Springer-Verlog, London 2001. Underwood in U.S. Pat. No. 6,601,233 describes a framework for business components. The documents listed above by Rackham, Veryard, and Underwood are hereby incorporated by reference in their entireties for any purpose.

The use of service-oriented architecture (SOA) techniques decouples interfaces from implementation through use of its service provider and service consumer structure. With SOA, services are the primary structuring element for business applications. Service-oriented architecture implementations are described in the papers “Service-Oriented Architecture: Programming Model and Product Architecture,” by Ferguson and Stockton, IBM Systems Journal, Volume 44, No. 4, October 2005, pp. 753-780, and “Impact of Service Orientation at the Business Level,” by Cherbakov et al., IBM Systems Journal, Volume 44, No. 4, December 2005, pp. 653-668. These two papers are hereby incorporated by reference.

Service-oriented modeling is necessary to build a service-oriented architecture. Service-oriented modeling includes identification, specification, and realization of services, components, and flows. It requires modeling the attributes of each service and their relationships. It is a method for the analysis and design of services.

Service-oriented modeling methods 14, therefore, take their inputs from component based modeling approaches 12 and deliver their outputs to a service-oriented architecture implementation 16 as shown in FIG. 1. While various technologies have been used for service-oriented modeling in the recent past, there exists a desire for improvement and enhancements to these techniques. It is believed that such improvements would constitute a significant contribution to the business modeling arts.

### OBJECTS AND SUMMARY OF THE INVENTION

It is therefore a principal object of the present invention to provide an improved service-oriented modeling method.

It is another object to provide such a method wherein enhanced service-oriented architecture implementations are possible.

It is yet another object of the invention to provide a method for service-oriented modeling which can be accomplished in a facile manner.

These and other objects are attained in accordance with one embodiment of the invention wherein there is provided a method of determining services for a business, comprising the steps of, identifying goals and sub-goals for a business, identifying services for fulfilling each of the sub-goals; and identifying performance indicators for each of the sub-goals, each of the indicators having a metric for the corresponding service.

In accordance with another embodiment of the invention, there is provided a method of evaluating a service for exposure, comprising the steps of; performing a business alignment test, performing a composability test, performing an externalized service description test, and exposing the service only when all of the tests are successfully passed.

### BRIEF DESCRIPTION OF THE DRAWINGS

FIG. 1 is a high-level flowchart of a client engagement process;

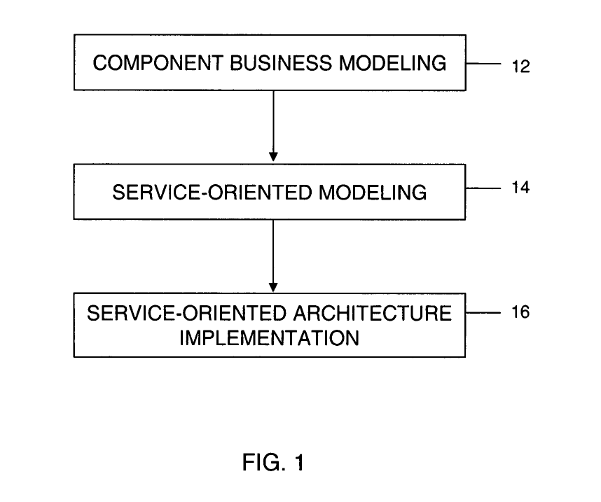

FIG. 2 is a diagram of a service-oriented models;

FIG. 3 shows approaches for filling a service portfolio;

FIG. 4 is a flowchart listing steps of a goal-service modeling method; and

FIG. 5 is a flowchart of tests to determine if a candidate service should be exposed.

### BEST MODE FOR CARRYING OUT THE INVENTION

For a better understanding of the present invention, together with other and further objects, advantages and capabilities thereof, reference is made to the following disclosure and the appended claims in connection with the above-described drawings.

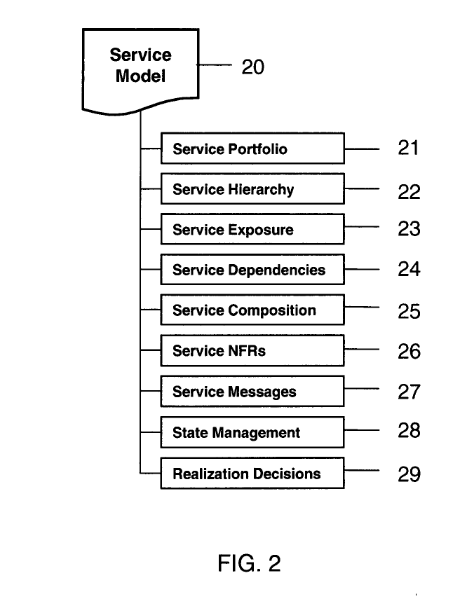

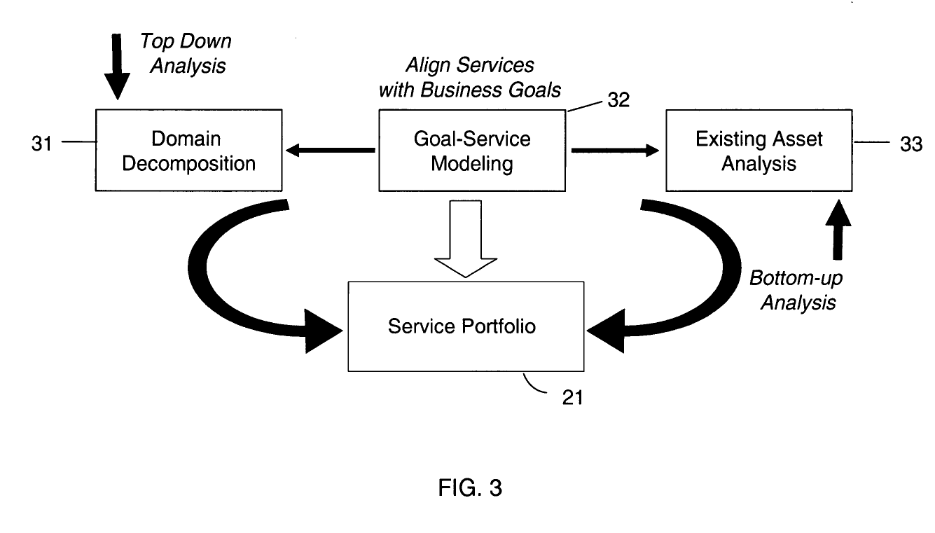

In FIG. 2, there is shown the elements 21-29 of service-oriented model 20. Service portfolio 21 has candidate services discovered during service-oriented modeling identification activities. These activities involve three complementary approaches as shown in FIG. 3. Domain decomposition 31 is a top-down business-driven view which analyzes key business aspects to identify services. Goal-service modeling 32 establishes alignment between services and business goals, and is the principal subject matter of the present invention. Existing asset analysis 33 identifies functionality that can be exposed as services using multiple asset sources such as existing systems and industry models.

As used herein, a service is taken to mean a software resource with an externalized service specification. This service specification is available for searching, binding, and invocation by a service consumer. A service provider realizes the service specification implementation and also delivers the quality of service required by the service consumer. Services are governed by declarative policies and thus support a dynamically re-configurable architectural style.

A domain shall be taken to denote a large business area consisting of a logical grouping of business capabilities that provide related business functions and require similar skills and expertise, such as financial services management, product development, or business administration. A domain corresponds to a component business modeling (CBM) competency.

Services hierarchy 22 consists of candidate services organized using a business significant categorization scheme. This makes evaluation of the candidate service more manageable, and helps avoid unnecessary service proliferation. The categorization may be as simple as an outline or as involved as semantic web taxonomy or ontology. The service exposure element 23 lists decisions of why a given candidate service in service hierarchy 22 was exposed. Service dependencies 24 lists dependencies between services in model 20. Service composition 25, if needed, is a choreography of service to form a composite service. Service NFRs 26 are non-functional requirements of the services. Service messages 27 are messages that are exchanged between a service consumer and a service provider. State management 28 are architectural decisions relating to state management. Realization decisions 29 are architectural decisions dealing with how the services will be realized, such as buy, build, or subscribe.

Goal-service modeling 32 identifies services for portfolio 21 by linking business goals with services that will fulfill these. Business organizations define goals to meet their mission and to set strategic direction. The terms goals, business goals, and strategic goals are often used to mean business aspirations. As used herein, the term goal shall denote a business aspiration, such as increase revenue by five percent.

Once a business has analyzed its mission and defined its goals, it needs a way to measure progress toward those goals. Key performance indicators (KPIs), also known as key success indicators or key business indicators are used by businesses to define and measure progress toward their goals. As used herein, KPIs represent quantifiable, measurable objectives, agreed to beforehand, that reflect the critical success factors of an organization.

KPIs differ depending on an industry or organization. A sales organization may use the percentage of its sales that come from return customers. A customer service organization may measure the number of customer service calls answered in less than one minute. To determine if the objectives associated with a KPI are being met, the KPI may need to be broken down into one or more metrics, which are specific measurements to collect for analysis, such as time to close an average sales deal.

While the primary objective of the goal-service modeling method is to align services with business goals and identify services, the method is also used to filter out those services that do not meet business goals. The identified services are added to service portfolio 21 along with services those services identified using the domain decomposition 31 and existing asset analysis 33 processes. Services added to portfolio 21 at this identification stage are service candidates, not a final decision on service exposure.

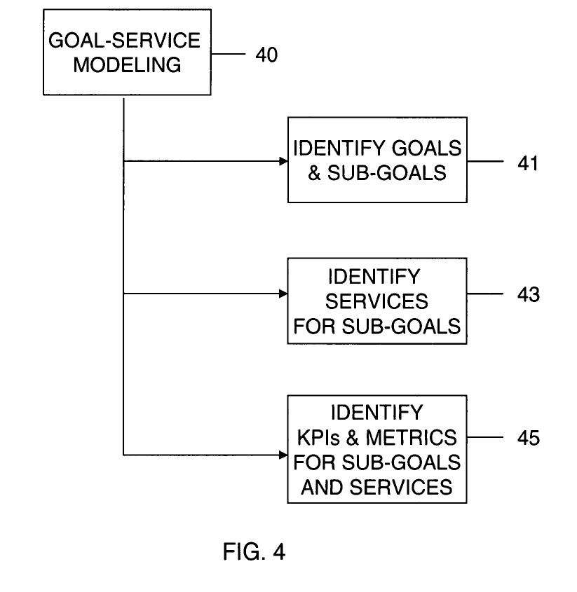

Using the goal-service modeling method 40 shown in FIG. 4 ensures that identified services are business aligned. In step 41, goals important to the business are identified. These goals are broken down into a set of sub-goals in a recursive fashion. Typically, three to four levels of sub-goals will suffice. However, the breaking down stops once the identified sub-goals reach a point at which services needed to fulfill the sub-goals can be identified in step 43.

Goals give an indication of what really matters to a business at a specific point in time and what will be a priority in the future. Therefore, goals are identified that are important within a context of an initial scoping effort for a project. For example, component business modeling or other business modeling and analysis methods may provide a means to define the scope and focus of a project. The focus area will be the context in which business goals are analyzed. High level goals tend to be vague, such as quality and revenue. These are broken down to more detailed sub-goals that are pre-requisites to the achievement of high level goals. The goals and sub-goals may be identified through interviews with executives and financial analysts in the business.

If new services are identified in step 43, they are added to service portfolio 21 of service model 20. In step 45, for each of the sub-goals, KPIs are identified that will be used to determine metrics that can be measured for the attainment of the sub-goals through the identified services. The KPIs will provide the business with a measure of success in meeting its goals and sub-goals. For example, for a goal of increase revenue, a KPI could be to increase revenue by five percent during the next fiscal year. This provides a specific way to determine if the goal has been met.

Metrics identify the type of measurements that need to be collected to assess the state of the KPIs. For the example KPI above, a metric could be to record the revenue from all revenue generating transactions.

The identified services and indicators may be entered into a database running on an information handling system (IHS), such as an ordinary workstation computer, laptop, server, or the like. Software code may also be running on the IHS for assisting the identifying and entry of goals and sub-goals. Code may also assist in identifying and entry of services, indicators, and metrics into the database. The code may be created and executed in any known programming language.

Once candidate services have been identified and entered into service portfolio 21, it is necessary to determine which of these candidate services should be exposed. As used herein, exposed shall be taken to mean generating a service description which can be shown to customers and to fund the creation of a component that will provide the functionality of the service, as well as, the maintenance, monitoring, security, performance, and service level of the service. Although any candidate service could be exposed, not every candidate service should be exposed for economic, marketing, and performance reasons.

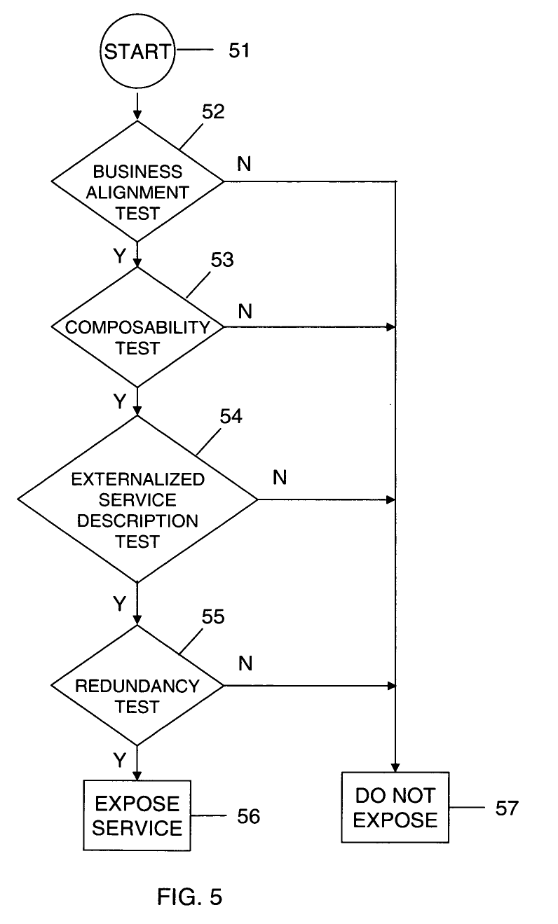

A method of determining which candidate services should be exposed for optimum business results is shown in FIG. 5. The method starts at step 51 by performing business alignment test 52. The purpose of business alignment test 52 is to insure the candidate service is traceable back to a business goal or sub-goal, such as but not limited to those identified in step 41.

Business alignment test 52 may comprise the questions in Table 1 below, all of which must be answered positively in order for the candidate service to have business alignment and therefore pass test 52.

TABLE 1

| | |
|---|---|
| 1. | Does the service provide a required unit of business |
| | functionality that supports business processes and goals? |
| 2. | Is the business willing to fund the service through its |
| | lifecycle: provisioning, management, governance and |
| | maintenance? |
| 3. | Is the business willing to share the service internally or |
| | externally with clients or business partners? |

Composability test 53 determines whether a candidate service is able to participate in a composition. That is, can the service be combined with other services in a choreography for a business solution. For example, services are typically developed in a specific context. To be composable, a service should be able to be used in a different context from the one in which it was developed. If the service is dependent on a relatively large number of other services each of which are not guaranteed to be accessible in the new context, or do not conform to service level agreements in the new context, then the service will not be considered a composable service.

A composability test may comprise the set of questions shown below in Table 2. All three questions must be answered positively in order to pass the test. However, the first question can be answered positively if any one of its sub-questions are answered positively.

TABLE 2

| | |
|---|---|
| 1. | When the functionality and Quality of Service (QoS) are met |
| | by a service, does the service satisfy one or more of the |
| | following tests? |
| a. | Can the service be used by the business stakeholder within |
| | all processes where required (i.e., substitution)? |
| b. | Can the service be provisioned once and leveraged, re-used |
| | as a single point of access for recurrent business |
| | functions? That is, the service fosters the elimination of |
| | redundancy. |
| c. | Can the business stakeholder re-compose the service in |
| | other business processes or applications to meet new |
| | business goals and support changes to processes? |
| 2. | Does the service manage its own state (akin to a |
| | transaction having ACID properties) and not rely on |
| | session? That is, the service can be deployed |
| | independently to meet a business goal although it may |
| | cooperate with other services at run-time to perform |
| | business processes. |
| 3. | Does the service require the usage of a pre-defined |
| | workflow or set of presentation services? This test |
| | distinguishes between the invocations of an application |
| | through a service description versus a service which is |
| | channel neutral. |

External service description test 54 determines whether a candidate service has an interface (either propriety or open) that is externalized and discovered, i.e., can be discovered through its meta-data. For example, a WSDL (web services description language) or XML (extensible markup language) representation of an internal format may comprise the interface specification in the case of legacy services.

External service description test 54 may comprise the questions shown below in Table 3. All of the questions must be answered positively in order to pass test 54.

TABLE 3

| | |
|---|---|
| 1. | Does the service have an externalized service description |
| | that is distinct and separate from the underlying physical |
| | implementation? |
| 2. | Can the service be discovered using the service |
| | description? |
| 3. | Does the description expose service functionality versus |
| | method calls? |
| 4. | Does the service description contain meta-data about |
| | itself? That is, the service description must be self- |
| | sufficient, containing or referencing all of the |
| | information necessary to understand the message exchange |
| | between consumer and provider of a service? |
| 5. | If policies are needed, does the service description |
| | include declarative policies? |

Redundancy test 55 determines whether a candidate service can be eliminated. A redundancy test may comprise the question shown below in Table 4.

TABLE 4

| | |
|---|---|
| 1. | Can this service be used by the business within all |
| | processes where its function is required? |

As shown in FIG. 5, tests 52, 53, 54, and 55 must all be passed in order to proceed to step 56 of exposing the candidate service. Or stated another way, failure to pass any one of tests 52, 53, 54, or 55 forces one to proceed to step 57 and not expose the candidate service. Although tests 52, 53, 54, and 55 are shown sequentially in FIG. 5, they may be performed in any order as will be obvious to those skilled in the art.

It is important to take note that a candidate service which is not chosen for exposure using the method of FIG. 5, may still be required in an overall solution. Such a service will not appear as a discoverable service, but may be implemented at a higher layer, such as at a component layer rather than at the services or choreography layer.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of evaluating a service for exposure, comprising the steps of:
performing a business alignment test;
performing a composability test;
performing an externalized service description test;
performing a redundancy test; and
exposing said service only when all of said tests are successfully passed.

2. The method of claim 1, wherein each of said tests has a plurality of questions and a positive answer is required for all of said plurality of questions to successfully pass said each of said tests.

3. The method of claim 2, wherein said business alignment test comprises questions of: does the service provide a required unit of business functionality that supports business processes and goals; is the business willing to fund the service through its lifecycle of provisioning, management, governance, and maintenance; and is the business willing to share the service internally or externally with clients or business partners.

4. The method of claim 2, wherein said composability test comprises questions of: can the service be used by the business stakeholder within all processes where required, or can the service be provisioned once and leveraged as a single point of access for recurrent business functions, or can the business stakeholder re-compose the service in other business processes or application to meet new business goals; and does the service manage its own state and not rely on session; and does the service require the use of a pre-defined workflow or set of presentation services.

5. The method of claim 2, wherein said externalized service description test comprises questions of: does the service have an externalized service description that is distinct and separate from the underlying physical implementation; can the service be discovered using the service description; does the description expose service functionality versus method calls; does the service description contain meta-data about itself; and if policies are needed, does the service description include declarative policies.

6. The method of claim 1, wherein said exposing step includes the step of funding the creation of a component that will provide the functionality of said service.

7. The method of claim 6, wherein said exposing step includes the step of funding the maintenance, monitoring, security, performance, and service level of said service.

8. A method of creating and exposing a services portfolio, comprising the steps of:
identifying goals and sub-goals for a business;
identifying services for fulfilling each of said sub-goals;
identifying performance indicators for each of said sub-goals, each of said indicators having a metric for the corresponding service;
for each identified service, performing a business alignment test, a composability test, an externalized service description test, and a redundancy test; and
exposing said identified service only when all of said tests are successfully passed.

9. The method of claim 8, further comprising the steps of creating a solution choreography by selecting a set of said exposed services, and implementing said solution as a services oriented architecture.

10. A system for evaluating services for exposure, comprising:
a database on an information handling system, having a portfolio of candidate services;
means for performing a business alignment test on each of said candidate services;
means for performing a composability test on each of said candidate services;
means for performing an externalized service description test on each of said candidate services;
means for performing a redundancy test;
a second database on said information handling system, having a portfolio of exposed services; and
means for entering each candidate service which passes all of said tests into said second database.

11. A method of deploying a solution to a client, comprising the steps of:
providing a portfolio of candidate services;
performing a business alignment test on each of said candidate services;
performing a composability test on each of said candidate services;
performing an externalized service description test on each of said candidate services;
performing a redundancy test;
exposing those candidate services which successfully pass each of said tests;
selecting a set of the exposed services for a solution for said client; and
implementing said solution as a services oriented architecture.
